(19) United States
(12) Patent Application Publication
(10) Pub. No.: US 2014/0133183 A1
(43) Pub. Date: May 15, 2014

(54) LIGHT GUIDING MEMBER, LIGHT EMITTING DEVICE, STATIC ELIMINATING DEVICE, AND IMAGE FORMING APPARATUS

(71) Applicant: FUJI XEROX CO., LTD., Tokyo (JP)

(72) Inventors: Tetsuya HAGIWARA, Kanagawa (JP); Osamu Ueno, Kanagawa (JP)

(21) Appl. No.: 13/914,819

(22) Filed: Jun. 11, 2013

(30) Foreign Application Priority Data
Nov. 9, 2012 (JP) 2012-247538

(51) Int. Cl. F21V 8/00

(52) U.S. Cl. CPC G02B 6/0036
USPC 362/626; 362/615

(57) ABSTRACT

A light guiding member includes a first end portion including an incident surface on which light emitted from a light source is incident; an emitting surface that extends in such a direction as to be at an angle to the incident surface, the emitting surface emitting the light that has been emitted from the light source and that has entered from the incident surface to a target object; and a second end portion including a reflection portion and a refraction portion, the reflection portion having a reflection surface that reflects the light that has entered from the incident surface in a direction away from the emitting surface, the refraction portion reflecting the reflected light that has been reflected by the reflection surface toward the incident surface and then refracting the light toward the emitting surface.

### CROSS-REFERENCE TO RELATED APPLICATIONS

This application is based on and claims priority under 35 USC 119 from Japanese Patent Application No. 2012-247538 filed Nov. 9, 2012.

### BACKGROUND

### Technical Field

The present invention relates to a light guiding member, a light emitting device, a static eliminating device, and an image forming apparatus.

### SUMMARY

According to an aspect of the invention, a light guiding member includes a first end portion including an incident surface on which light emitted from a light source is incident; an emitting surface that extends in such a direction as to be at an angle to the incident surface, the emitting surface emitting the light that has been emitted from the light source and that has entered from the incident surface to a target object; and a second end portion including a reflection portion and a refraction portion, the reflection portion having a reflection surface that reflects the light that has entered from the incident surface in a direction away from the emitting surface, the refraction portion reflecting the reflected light that has been reflected by the reflection surface toward the incident surface and then refracting the light toward the emitting surface.

### BRIEF DESCRIPTION OF THE DRAWINGS

An exemplary embodiment of the present invention will be described in detail based on the following figures, wherein:

FIG. 1 is a schematic diagram of an example of an image forming apparatus according to an exemplary embodiment;

FIGS. 2A, 2B, and 2C are schematic diagrams of an exemplary configuration of an erase lamp according to the exemplary embodiment, where FIG. 2A illustrates the entirety of the erase lamp, FIG. 2B is a perspective view of a portion of the erase lamp around a terminal portion, and FIG. 2C is a side view of the portion of the erase lamp around the terminal portion;

FIG. 3 illustrates a state of light that has entered from an incident surface of a light guiding path according to the exemplary embodiment and that has arrived at a terminal portion (first total reflection surface) of the light guiding path;

FIG. 4 illustrates a state of light that has arrived at the terminal portion as illustrated in FIG. 3 and then reflected by the first total reflection surface of the light guiding path according to the exemplary embodiment;

FIG. 5 is a table listing materials usually used for the light guiding path according to the exemplary embodiment and their indexes n of refraction and critical angles θc;

FIG. 6 illustrates a state of light that has entered from an incident surface of the light guiding path according to the exemplary embodiment and that has arrived at the terminal portion;

FIG. 7 illustrates a state of light that has been totally reflected as illustrated in FIG. 4 and then totally reflected by a second total reflection surface of the light guiding path according to the exemplary embodiment;

FIG. 8 illustrates a state of light that has been totally reflected by the second total reflection surface as illustrated in FIG. 7 and then refracted by a refraction surface of the light guiding path according to the exemplary embodiment;

FIG. 9 is a graph showing distribution of amounts of light in the light guiding path according to the exemplary embodiment and in a light guiding path according to a comparative example, the distribution being calculated by simulation;

FIG. 10 schematically illustrates a modification of the light guiding path according to the exemplary embodiment in which the terminal portion is modified;

FIG. 11 schematically illustrates a modification of the light guiding path according to the exemplary embodiment in which the terminal portion is modified;

FIGS. 12A and 12B schematically illustrate a modification of the terminal portion of the light guiding path according to the exemplary embodiment, where FIG. 12A is a side view of the terminal portion and FIG. 12B is a perspective view of the terminal portion;

FIGS. 13A and 13B schematically illustrate a modification of the light guiding path according to the exemplary embodiment in which the terminal portion is modified, where FIG. 13A is a side view of the terminal portion and FIG. 13B is a perspective view of the terminal portion;

FIG. 14 schematically illustrates a modification of the light guiding path according to the exemplary embodiment in which the entire shape is modified;

FIGS. 15A, 15B, and 15C schematically illustrate a modification of the light guiding path according to the exemplary embodiment in which the entire shape is modified, where FIG. 15A is a top view of the light guiding path viewed from a prism surface side, FIG. 15B is a side view of the light guiding path, and FIG. 15C is an end view of the light guiding path viewed from a terminal portion side;

FIG. 16 schematically illustrates the entire shape of an example of the light guiding path according to the exemplary embodiment, in which the width H of an incident surface is larger than the width H of the terminal portion; and

FIG. 17 schematically illustrates the entire shape of an example of the light guiding path according to the exemplary embodiment, in which the width H of the terminal portion is larger than the width H of the incident surface.

### DETAILED DESCRIPTION

Referring to the drawings, an exemplary embodiment of the present invention is described below in detail.

### (Image Forming Apparatus)

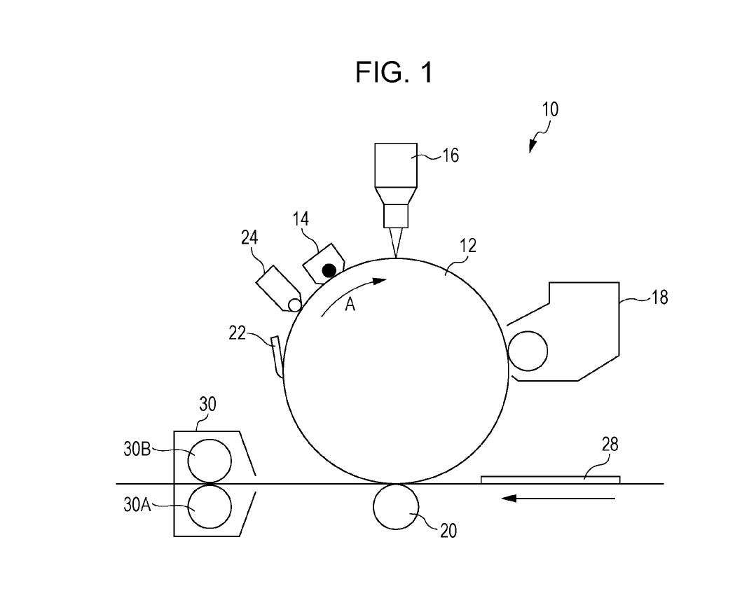

FIG. 1 is a schematic diagram of an example of an image forming apparatus 10 according to an exemplary embodiment.

The image forming apparatus 10 according to the exemplary embodiment includes a photoconductor 12 that rotates at a fixed speed in a direction of arrow A of FIG. 1.

A charging device 14, a light source head 16 (exposure unit), a developing device 18 (developing unit), a transfer body 20 (transfer unit), a cleaner 22, and an erase lamp 24 (static eliminating device) are arranged around the photoconductor 12 in order in a direction of rotation of the photoconductor 12. The charging device 14 charges the surface of the photoconductor 12. The light source head 16 exposes the surface of the photoconductor 12 charged by the charging device 14 to light to form an electrostatic latent image. The developing device 18 develops the electrostatic latent image with a developer to form a toner image. The transfer body 20 transfers the toner image to a sheet 28 (recording medium). The cleaner 22 removes a toner remaining on the photoconductor 12 after transfer. The erase lamp 24 eliminates static from the photoconductor 12 so that the photoconductor 12 has a uniform potential.

In other words, after the surface of the photoconductor 12 is charged by the charging device 14, the photoconductor 12 is irradiated with a light beam by the light source head 16, so that a latent image is formed on the photoconductor 12. The light source head 16, which includes a light emitting element, is connected to a driving portion (not illustrated) and emits light beams in accordance with image data while the driving portion controls turning on and off of the light emitting element.

The developing device 18 supplies the formed latent image with a toner to form a toner image on the photoconductor 12. The toner image on the photoconductor 12 is transferred by the transfer body 20 to a sheet 28 that has been transported to the transfer body 20. A toner remaining on the photoconductor 12 after transfer is removed by the cleaner 22. After the electric charge remaining on the surface of the photoconductor 12 is eliminated by light emitted by the erase lamp 24, the photoconductor 12 is charged again by the charging device 14 and repeats the same operations.

The sheet 28 to which the toner image has been transferred is transported to a fixing device 30 including a pressure roller 30A and a heat roller 30B and undergoes a fixing operation. Thus, the toner image is fixed to the sheet 28 and a desired image is formed on the sheet 28. The sheet 28 on which the image is formed is ejected outside the apparatus.

### Erase Lamp

Now, the erase lamp 24 according to the exemplary embodiment and a light guiding path (light guiding member) used as an example of the erase lamp 24 are described in detail below.

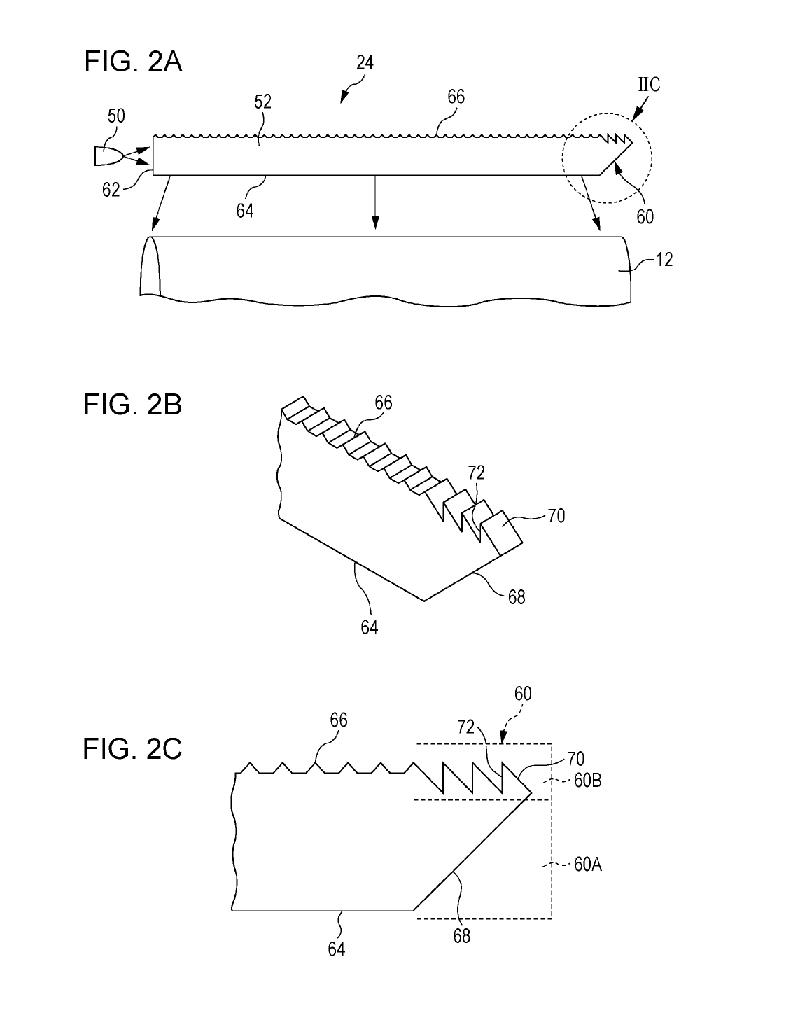

Firstly, configurations of the erase lamp 24 according to the exemplary embodiment and a light guiding path are described. FIGS. 2A to 2C schematically illustrate an example of a configuration of the erase lamp 24 according to the exemplary embodiment. FIG. 2A illustrates the entirety of the erase lamp 24, FIG. 2B is a perspective view of a portion around a terminal portion, and FIG. 2C is a side view of a portion around the terminal portion.

As illustrated in FIG. 2A, the erase lamp 24 according to the exemplary embodiment extends along the rotation axis of the photoconductor 12. The erase lamp 24 includes a light source 50 and a light guiding path 52 having a length equivalent to the length of the photoconductor 12 in the direction of its rotation axis.

The light source 50 has a function of emitting light to eliminate electric charge remaining on the photoconductor 12. A single light source is used in the exemplary embodiment. Preferably, any of a light emitting device (LED), an end surface emitting laser, and a vertical-cavity surface-emitting laser (VCSEL) is used as the light source 50.

The light guiding path 52 has a long shape having a length equivalent to the length of the photoconductor 12 in the direction of the rotation axis of the photoconductor 12 so that light is emitted from the emitting surface 64 to the entirety of the surface of the photoconductor 12 along the rotation axis of the photoconductor 12. The light guiding path 52 according to the exemplary embodiment includes an incident surface 62, from which light emitted from the light source 50 is incident, an emitting surface 64, which emits the incident light to the photoconductor 12, a prism surface 66, which diffuses the incident light toward the emitting surface 64, a first total reflection surface 68 (reflection surface), second total reflection surfaces 70 (inclined surfaces), and refraction surfaces 72 (transmissive surfaces). Examples of materials of the light guiding path 52 include glass and transparent resins, such as polystyrene resin, styrene acrylonitrile resin, polymethyl methacrylate resin, polycarbonate resin, and polyethylene terephthalate resin.

The prism surface 66 includes multiple prisms to guide light incident from the incident surface 62 to the emitting surface 64. The prism surface 66 has a function of refracting and diffusing the light that has arrived at the prism surface 66 toward the emitting surface 64 by using the prisms. The multiple prisms formed on the prism surface 66 may be provided at the uniform or different intervals (density), may have the same size or different sizes, and may have the same area or different areas. The intervals at which prisms are provided or the size of each prism are/is preferably determined such that light reflected by the prisms is uniformly emitted from the emitting surface 64 to the photoconductor 12. Instead of providing the prism surface 66, the surface facing the emitting surface 64 may be formed into a flat surface. However, in order to increase the amount of light emitted from the emitting surface 64 and to make the amount of light uniform, it is preferable that the prism surface 66 be included as in the case of the exemplary embodiment.

The first total reflection surface 68, the second total reflection surfaces 70, and the refraction surfaces 72 of the light guiding path 52 are formed at a terminal portion 60 of the light guiding path 52. Hereinbelow, as illustrated in FIG. 2C, a region of the terminal portion 60 in which the first total reflection surface 68 is formed is referred to as a terminal reflection portion 60A while a region of the terminal portion 60 in which the second total reflection surfaces 70 and the refraction surfaces 72 are formed is referred to as a terminal refraction portion 60B. When the incident surface 62 is referred to as a first end portion of the light guiding path 52, the terminal portion 60 is a second end portion of the light guiding path 52 that is opposite to the first end portion.

The first total reflection surface 68 has a function of reflecting light that has arrived at the terminal portion 60 (terminal reflection portion 60A) in a direction away from the emitting surface 64 (toward the prism surface 66 and the terminal refraction portion 60B).

In this exemplary embodiment, the multiple second total reflection surfaces 70 and refraction surfaces 72 are provided in the terminal refraction portion 60B. The terminal refraction portion 60B has a function of reflecting reflected light that has been reflected by the first total reflection surface 68 toward the incident surface 62 and then refracting the light toward the emitting surface 64. The second total reflection surfaces 70 have a function of reflecting reflected light that has been reflected by the first total reflection surface 68 toward the incident surface 62. The refraction surfaces 72 have a function of refracting the light that has been reflected by the second total reflection surfaces 70 toward the emitting surface 64.

It is preferable that multiple second total reflection surfaces 70 and refraction surfaces 72 be provided. However, the number of second total reflection surfaces 70 and refraction surfaces 72 formed in the terminal refraction portion 60B or the size of the surfaces 70 and 72 may be appropriately determined such that light that has been guided to the emitting surface 64 by being reflected and refracted in the terminal refraction portion 60B is substantially uniformly emitted to the photoconductor 12. The number of second total reflection surfaces 70 and refraction surfaces 72 or the size of the surfaces 70 and 72 may be determined in accordance with the material, shape, or other conditions of the light guiding path 52.

Now, an operation of guiding light that has arrived at the terminal reflection portion 60A to the emitting surface 64 in the light guiding path 52 according to the exemplary embodiment will be described.

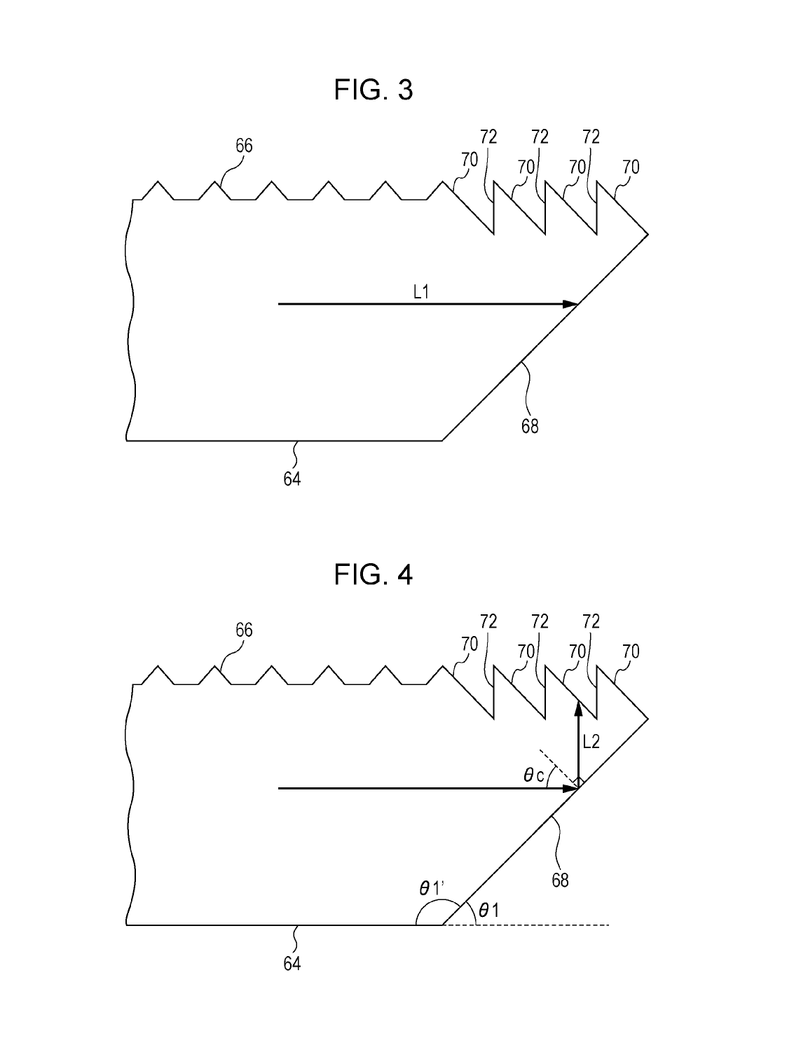

FIG. 3 illustrates light that has entered from the incident surface 62 and arrived at the terminal portion 60 (first total reflection surface 68). Arrow L1 of FIG. 3 indicates a direction in which the light that has entered from the incident surface 62 and arrived at the terminal portion 60 (first total reflection surface 68) moves. Since the light guiding path 52 according to the exemplary embodiment is long, the light that has arrived at the terminal portion 60 is a parallel light that is substantially parallel to the light guiding path 52.

FIG. 4 illustrates light that is reflected by the first total reflection surface 68. Arrow L2 of FIG. 4 indicates a direction in which the light that has been reflected by the first total reflection surface 68 moves. As illustrated in FIG. 4, the light that has arrived at the first total reflection surface 68 is reflected by the first total reflection surface 68 in a direction away from the emitting surface 64. Here, in order to reflect the light that has arrived at the terminal portion 60 and whose incident angle is larger than or equal to a critical angle θc toward the inside of the light guiding path 52 and to prevent the light from passing through the terminal portion 60 (first total reflection surface 68) to the outside, an angle θ1′ formed between the first total reflection surface 68 and the emitting surface 64 (an angle on the inner side of the light guiding path 52) is set to be larger than or equal to 90 degrees+θc while an angle θ1 is set to be smaller than or equal to 90 degrees−θc. The critical angle θc is determined by the index n of refraction of the material of the light guiding path 52 and is calculated by the following equation (1):

θc=sin⁻¹(1/n) (1).

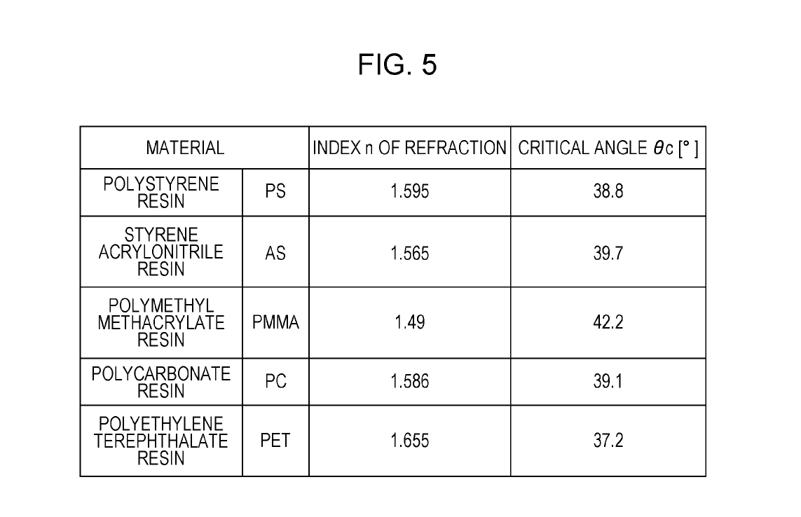

FIG. 5 is a table listing materials usually used for the light guiding path 52 and their indexes n of refraction and critical angles θc.

A large part of light that arrives at the terminal portion 60 of the long light guiding path 52 is substantially parallel to the emitting surface 64 (the light is parallel light). Thus, by determining the angles θ1′ and θ1 of the first total reflection surface 68 in this manner, the light is capable of being efficiently reflected (totally reflected).

In the case where the emitting surface 64 does not extend substantially parallel to the parallel light emitted from the light source 50, for example, in the case where the incident surface 62 of the light guiding path 52 has a small width H and the terminal portion 60 of the light guiding path 52 has a large width H, the incident angle of the parallel light emitted from the light source 50 only has to be set larger than or equal to the critical angle θc regardless of the angles θ1′ and θ1.

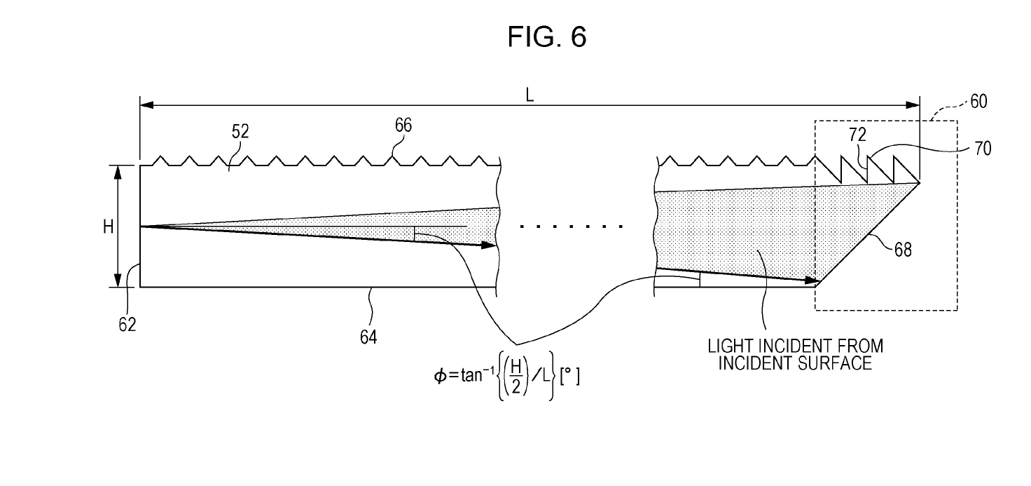

As illustrated in FIG. 6, the light guiding path 52 according to the exemplary embodiment includes the first total reflection surface 68 in order to guide as much light to the surface facing the emitting surface 64 as possible, i.e., in order that not only the parallel light that has arrived at the terminal portion 60, but also the light that has arrived at the terminal portion 60 without being reflected by the prism surface 66 or other portions is reflected by the surface that faces the emitting surface 64. Here, the light that has arrived at the terminal portion 60 without being reflected by the prism surface 66 or other portions is light that forms an angle with the emitting surface 64 that is smaller than or equal to an angle φ calculated by the following equation (2), where H in the equation (2) denotes the width (distance between the emitting surface 64 and the prism surface 66) of the light guiding path 52 at the incident surface 62 and L in the equation (2) denotes the length of the light guiding path 52 in the longitudinal direction, as illustrated in FIG. 6:

φ=tan⁻¹{(H/2)/L} (2).

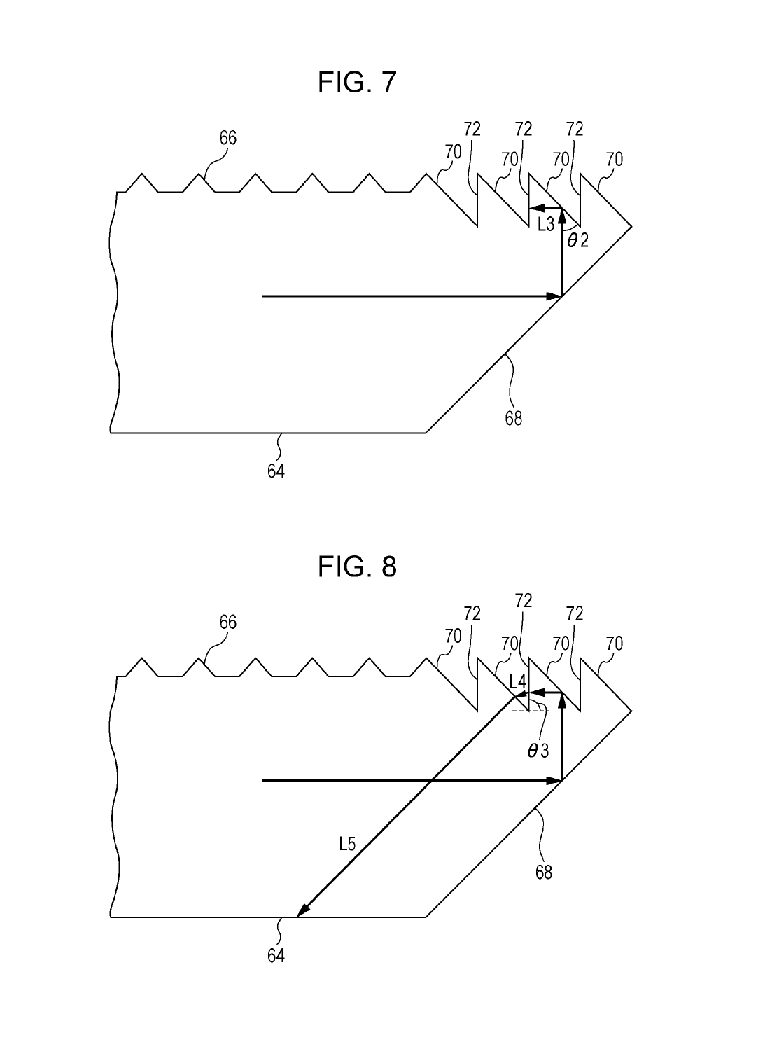

Now, FIG. 7 illustrates light that is reflected by the second total reflection surface 70. Arrow L3 of FIG. 7 indicates the direction in which light reflected by one of the second total reflection surfaces 70 moves. As illustrated in FIG. 7, light that has been reflected by the first total reflection surface 68 is reflected by the second total reflection surface 70 toward the incident surface 62 and arrives at one of the refraction surfaces 72.

Here, in order that the light that has arrived at one of the second total reflection surfaces 70 is reflected toward the incident surface 62 inside the light guiding path 52, each second total reflection surface 70 is formed such that light is incident on the second total reflection surface 70 at an incident angle that is larger than or equal to the critical angle θc. In other words, an angle θ2 formed between each second total reflection surface 70 and the light reflected by the first total reflection surface 68 is set to be smaller than or equal to an angle 90 degrees−θc.

FIG. 8 illustrates light that is refracted by one of the refraction surfaces 72. Arrow L4 of FIG. 8 indicates a direction in which the light refracted by the refraction surface 72 moves. As illustrated in FIG. 8, the light reflected by one of the second total reflection surfaces 70 is refracted by a corresponding one of the refraction surfaces 72 and temporarily emitted to the outside of the light guiding path 52. Thereafter, the light is again incident on the inside of the light guiding path 52 from another one of the second total reflection surfaces 70 facing the refraction surface 72 and is guided to the emitting surface 64 (see arrow L5 of FIG. 8).

Here, in order to refract the light that has been reflected by each second total reflection surface 70 and guide the light to the emitting surface 64, an angle θ3 formed between each refraction surface 72 and the prism surface 66 is set to be larger than or equal to 90 degrees.

Although part of light that has been reflected by each second total reflection surface 70 might not be refracted when passing through the corresponding refraction surface 72, this part of light may also be guided to the emitting surface 64 if it is refracted toward the emitting surface 64 when incident from another second total reflection surface 70.

The light that has thus been guided to the emitting surface 64 is emitted from the emitting surface 64 to a target object.

As described above, the light guiding path 52 of the erase lamp 24 according to the exemplary embodiment includes the incident surface 62, on which light emitted from the light source 50 is incident, the emitting surface 64, which emits light to the photoconductor 12, and the terminal reflection portion 60A and the terminal refraction portion 60B, which are formed in the terminal portion 60. The first total reflection surface 68, which reflects incident light that has entered from the incident surface 62 in a direction away from the emitting surface 64 (toward the terminal refraction portion 60B), is formed in the terminal reflection portion 60A. The second total reflection surfaces 70, which reflect the reflected light that has been reflected by the first total reflection surface 68 toward the incident surface 62, and the refraction surfaces 72, which refract the reflected light that has been reflected by the second total reflection surfaces 70, are formed in the terminal refraction portion 60B.

The light that has arrived at the terminal portion 60 is reflected by the first total reflection surface 68 and then again reflected by the second total reflection surfaces 70. The light then passes through the refraction surfaces 72 to be temporarily emitted to the outside of the light guiding path 52. Thereafter, the light is again incident on the inside of the light guiding path 52 from the second total reflection surfaces 70. During a period after the light passes through the refraction surfaces 72 and before the light is again incident from the second total reflection surfaces 70, the light is refracted toward the emitting surface 64.

Thus, the light that has arrived at the terminal portion 60 is capable of being emitted from the emitting surface 64 to the photoconductor 12 without passing through the terminal portion 60 to the outside.

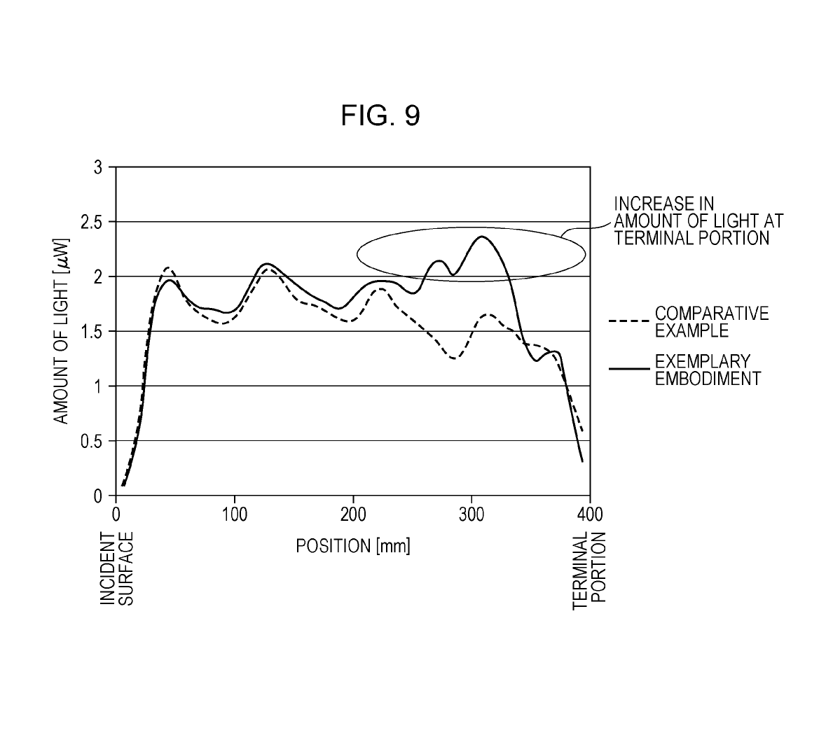

FIG. 9 is a graph showing distribution of amounts of light calculated by simulation. The graph of FIG. 9 includes distribution of amount of light in the light guiding path 52 (erase lamp 24) according to the exemplary embodiment and distribution of amount of light in a light guiding path according to a comparative example in which the terminal portion has a configuration different from that according to the exemplary embodiment (in which the end face of the terminal portion is substantially parallel to the incident surface).

In the case of the comparative example, a small amount of light arrives at the terminal portion and a large amount of light passes through the end surface of the terminal portion to the outside. On the other hand, the light guiding path 52 according to the exemplary embodiment is configured so as not to allow the light that has arrived at the terminal portion 60 to pass through the terminal portion 60 to the outside. As is clear from FIG. 9, the amount of light at or around the terminal portion 60 of the light guiding path 52 according to the exemplary embodiment is larger than that at or around the terminal portion of the light guiding path according to the comparative example. In addition, since the multiple second total reflection surfaces 70 and refraction surfaces 72 formed in the terminal refraction portion 60B reflect and refract the reflected light that has been reflected by the first total reflection surface 68, the light guided to the emitting surface 64 is distributed to a wide range of the photoconductor 12 without being localized to a portion of the photoconductor 12 near the terminal portion 60.

Thus, as illustrated in FIG. 9, in the light guiding path 52 according to the exemplary embodiment, the amount of light emitted from the emitting surface 64 to the photoconductor 12 is made substantially uniform.

The light guiding path 52 according to the exemplary embodiment only has the first total reflection surface 68, the second total reflection surfaces 70, and the refraction surfaces 70 in the terminal portion 60 and is not additionally equipped with a reflection member or other members in the terminal portion 60. Thus, the cost for manufacturing the light guiding path 52 is reduced compared to that in the case of manufacturing a light guiding path equipped with a reflection member.

In the exemplary embodiment, the terminal reflection portion 60A is larger than the terminal refraction portion 60B. Thus, the amount of light guided to the terminal refraction portion 60B is increased and the amount of light emitted from the emitting surface 64 is made substantially uniform.

The exemplary embodiment is an example of the present invention and is changeable, if needed, within a scope not departing from the gist of the present invention. Hereinbelow, modifications of the light guiding path 52 are described as other examples of the present invention.

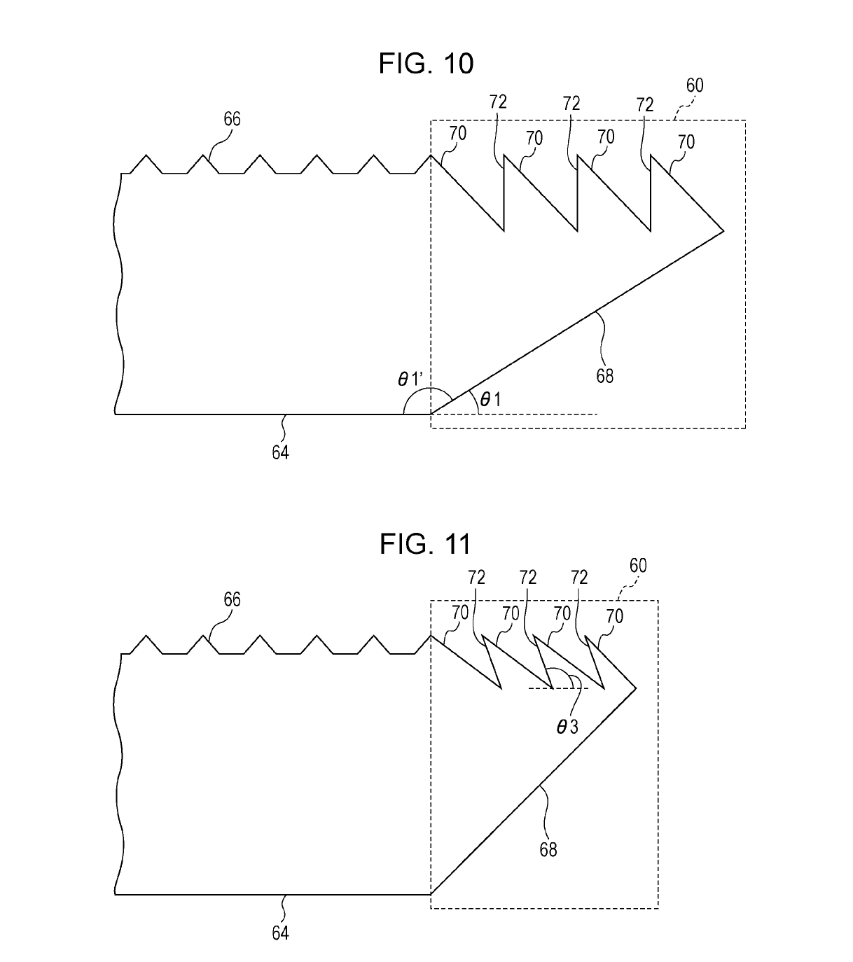

Referring now to FIGS. 10 to 13B, modifications of the light guiding path 52 in which the terminal portion 60 is modified will be described.

FIG. 10 illustrates a modification in which the angle θ1 of the first total reflection surface 68 is smaller than that at the terminal portion 60 of the light guiding path 52 according to the exemplary embodiment. Even in this case, the same effects are obtained as long as the angle θ1 (angle θ1′) falls within the above-described range. FIG. 11 illustrates a modification in which the angle θ3 of the refraction surface 72 is larger than that at the terminal portion 60 of the light guiding path 52 according to the exemplary embodiment. Even in this case, the same effects are obtained as long as the angle θ3 falls within the above-described range.

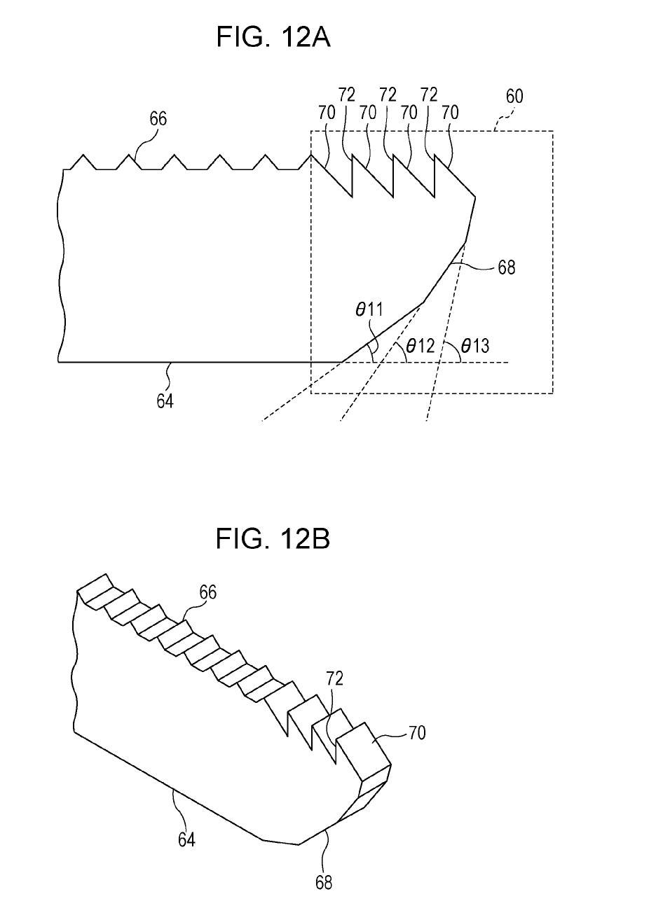

FIGS. 12A and 12B illustrate a modification in which the first total reflection surface 68 in the terminal reflection portion 60A of the terminal portion 60 is formed of multiple reflection surfaces. FIG. 12A is a side view of the terminal portion 60 of the light guiding path 52 and FIG. 12B is a perspective view of the terminal portion 60. As illustrated in FIG. 12A, the first total reflection surface 68 is formed of a reflection surface having an angle θ11, a reflection surface having an angle θ12, and a reflection surface having an angle θ13. The terminal portion 60 having this configuration has high mechanical strength. In addition, a larger amount of light that has arrived at the terminal portion 60 other than the parallel light is reflected toward the terminal refraction portion 60B. Preferably, the angles θ11, θ12, and θ13 satisfy the conditions of the angle θ1.

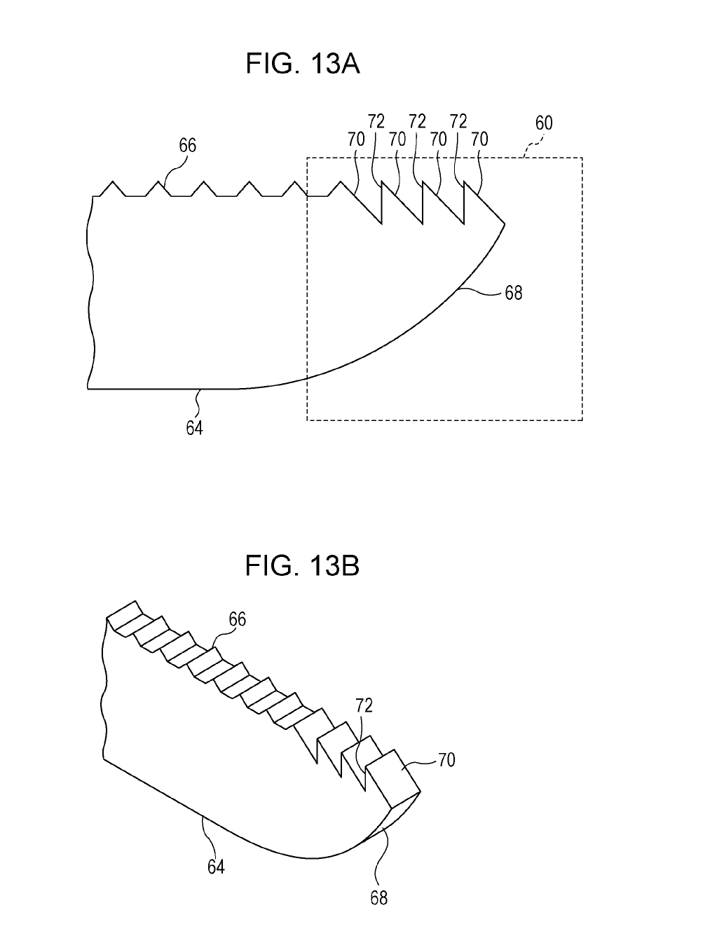

FIGS. 13A and 13B illustrate a modification in which the first total reflection surface 68 in the terminal reflection portion 60A of the terminal portion 60 is a curved surface. FIG. 13A is a side view of the terminal portion 60 of the light guiding path 52 and FIG. 13B is a perspective view of the terminal portion 60. In this case, effects that are the same as those obtained in the case where the first total reflection surface 68 is formed of multiple reflection surfaces as illustrated in FIGS. 12A and 12B are obtained.

Similarly to the first total reflection surface 68, the second total reflection surfaces 70 and the refraction surfaces 72 may be curved surfaces.

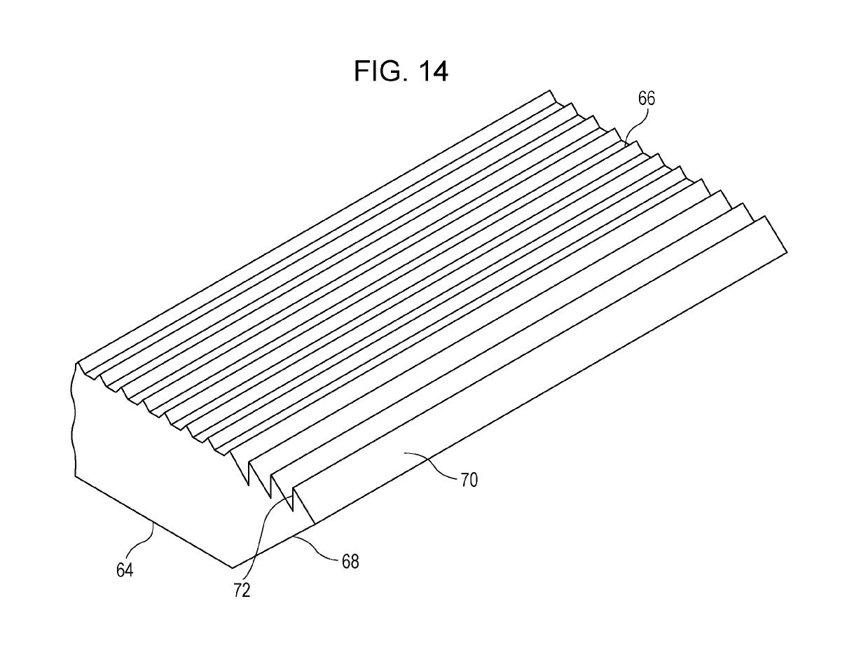

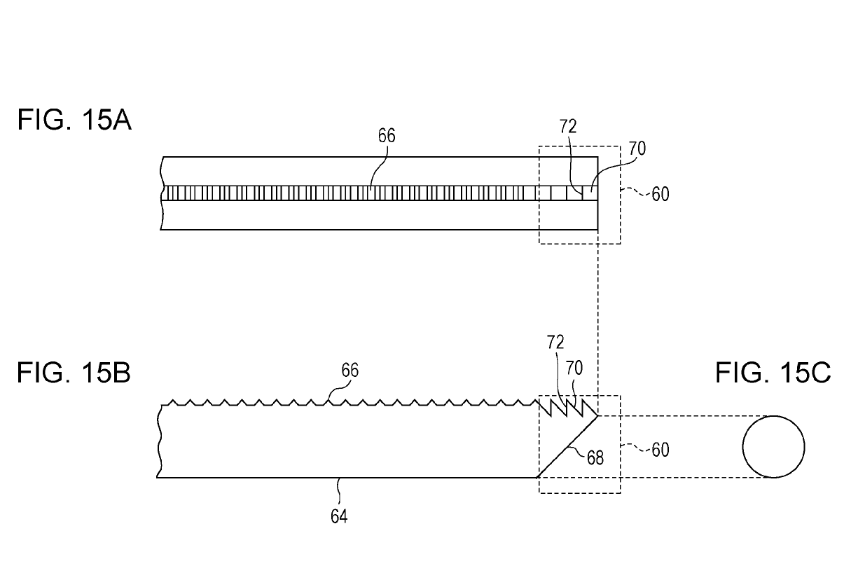

FIGS. 14 to 17 illustrate modifications in which the entire shape of the light guiding path 52 is modified. FIG. 14 is a perspective view of a modification in which the entirety of the light guiding path 52 has a wide shape. FIGS. 15A and 15B are perspective views of a modification in which the entirety of the light guiding path 52 has a cylindrical shape. FIG. 15A is a top view of the modification when viewed from the prism surface 66 side, FIG. 15B is a side view of the modification, and FIG. 15C is an end view of the modification when viewed from the terminal portion 60 side.

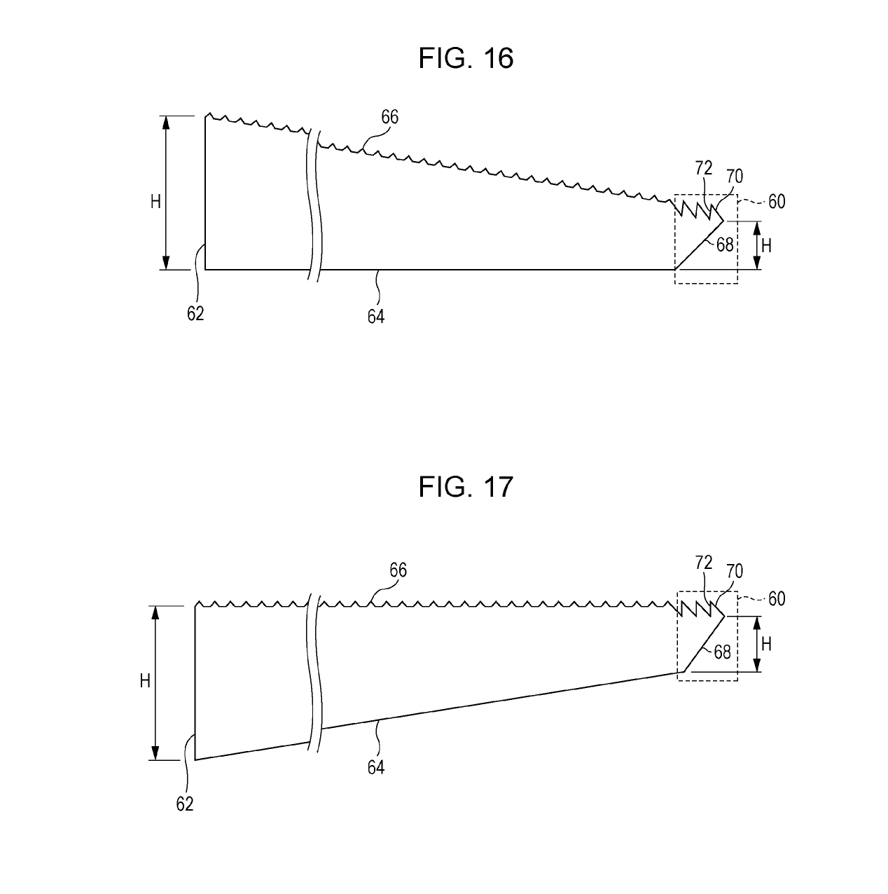

The widths H of the light guiding path 52 may be different in the incident surface 62 and the terminal portion 60. FIGS. 16 and 17 illustrate examples in which the width H of the incident surface 62 is larger than the width H of the terminal portion 60. FIG. 16 illustrates a case where the prism surface 66 is inclined (with respect to the photoconductor 12). FIG. 17 illustrates a case where the emitting surface 64 is inclined (with respect to the photoconductor 12). The emitting surface 64 and the prism surface 66 may both be inclined. Alternatively, the width H of the terminal portion 60 may be larger than the width H of the incident surface 62.

The shape of the light guiding path 52 may be appropriately determined in consideration of whether or not light is capable of being substantially uniformly emitted from the emitting surface 64 to the photoconductor 12.

The exemplary embodiment of the present invention is applied to an erase lamp 24 included in an electrophotographic image forming apparatus 10 of a self-scanning type, but is not limited to this. The erase lamp 24 according to the exemplary embodiment may be applied to other types of image forming apparatuses. In the case where the erase lamp 24 is used as a light emitting device that emits light that has entered from the light source 50 to a target object, the erase lamp 24 may be used as a lighting device of another device, such as a scanner, or as a backlight of a liquid crystal display or the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light guiding member comprising:
a first end portion including an incident surface on which light emitted from a light source is incident;
an emitting surface that extends in such a direction as to be at an angle to the incident surface, the emitting surface emitting the light that has been emitted from the light source and that has entered from the incident surface to a target object; and
a second end portion including a reflection portion and a refraction portion, the reflection portion having a reflection surface that reflects the light that has entered from the incident surface in a direction away from the emitting surface, the refraction portion reflecting the reflected light that has been reflected by the reflection surface toward the incident surface and then refracting the light toward the emitting surface.

2. The light guiding member according to claim 1,
wherein the refraction portion includes a plurality of inclined surfaces arranged in such a direction as to be at an angle to the incident surface and at least one transmissive surface that is formed between the plurality of inclined surfaces and that allows light that has entered to pass therethrough,
wherein each of the inclined surfaces reflects the reflected light that has been reflected by the reflection surface toward a corresponding one of the at least one transmissive surface formed on an incident surface side of the inclined surface, and
wherein, in a case where light that has been reflected by any one of the inclined surfaces passes through the corresponding transmissive surface and/or a case where light that has passed through the corresponding transmissive surface is incident from another one of the inclined surfaces, the light is refracted toward the emitting surface.

3. The light guiding member according to claim 2, wherein each of the inclined surfaces is a total reflection surface on which light that has been reflected by the reflection surface is incident at an angle that is larger than or equal to a critical angle.

4. The light guiding member according to claim 2, wherein an angle on an inner side of the light guiding member formed between the at least one transmissive surface and a surface facing the emitting surface is larger than or equal to 90 degrees.

5. The light guiding member according to claim 3, wherein an angle on an inner side of the light guiding member formed between the at least one transmissive surface and a surface facing the emitting surface is larger than or equal to 90 degrees.

6. The light guiding member according to claim 1, wherein the reflection surface is a total reflection surface that forms an angle with the emitting surface on an inner side of the light guiding member, the angle being larger than or equal to an angle obtained by adding a critical angle to 90 degrees.

7. The light guiding member according to claim 2, wherein the reflection surface is a total reflection surface that forms an angle with the emitting surface on an inner side of the light guiding member, the angle being larger than or equal to an angle obtained by adding a critical angle to 90 degrees.

8. The light guiding member according to claim 3, wherein the reflection surface is a total reflection surface that forms an angle with the emitting surface on an inner side of the light guiding member, the angle being larger than or equal to an angle obtained by adding a critical angle to 90 degrees.

9. The light guiding member according to claim 4, wherein the reflection surface is a total reflection surface that forms an angle with the emitting surface on an inner side of the light guiding member, the angle being larger than or equal to an angle obtained by adding a critical angle to 90 degrees.

10. The light guiding member according to claim 5, wherein the reflection surface is a total reflection surface that forms an angle with the emitting surface on an inner side of the light guiding member, the angle being larger than or equal to an angle obtained by adding a critical angle to 90 degrees.

11. The light guiding member according to claim 1, wherein the reflection surface is a total reflection surface on which parallel light is incident from the incident surface at an angle larger than or equal to a critical angle.

12. The light guiding member according to claim 1, wherein the reflection surface reflects light that has arrived at the second end portion in a direction away from the emitting surface, the reflection surface forming an angle with the emitting surface that is smaller than or equal to an angle φ expressed by the following equation (1):
φ=tan⁻¹{(H/2)/L} (1),
where L denotes a distance from the first end portion to the second end portion and H denotes a width of the first end portion.

13. The light guiding member according to claim 1, wherein an area of the reflection portion is larger than an area of the refraction portion.

14. The light guiding member according to claim 1, further comprising a prism surface that includes a plurality of prisms arranged in such a direction as to be at an angle to the incident surface, the prism surface guiding light that has entered from the light source to the emitting surface.

15. A light emitting device comprising:
a light source; and
the light guiding member according to claim 1 on which light emitted from the light source is incident from the incident surface.

16. A static eliminating device comprising the light emitting device according to claim 15,
wherein the static eliminating device emits light that has been emitted from the light emitting device to a target object to eliminate electric charge from a surface of the target object.

17. An image forming apparatus comprising:
a photoconductor;
a charging unit that charges a surface of the photoconductor;
an exposure unit that exposes the surface of the photoconductor charged by the charging unit to form an electrostatic latent image on the surface;
a developing unit that develops the electrostatic latent image formed by the exposure unit into a toner image;
a transfer unit that transfers the toner image developed by the developing unit to a recording medium; and
the static eliminating device according to claim 16 that eliminates electric charge remaining on the surface of the photoconductor after the transfer unit transfers the toner image to the recording medium.
